(19) United States
(12) Patent Application Publication
(10) Pub. No.: US 2015/0306940 A1
(43) Pub. Date: Oct. 29, 2015

(54) VEHICLE HYPERTHERMIA AVOIDANCE

(71) Applicant: Ford Global Technologies, LLC, Dearborn, MI (US)

(72) Inventors: Stuart C. Salter, White Lake, MI (US); Lynn Adams, Belleville, MI (US); Cornel Lewis Gardner, Romulus, MI (US)

(73) Assignee: Ford Global Technologies, LLC, Dearborn, MI (US)

(21) Appl. No.: 14/259,276

(22) Filed: Apr. 23, 2014

(51) Int. Cl. B60J 7/02; B60H 1/00

(52) U.S. Cl. CPC B60J 7/02; B60H 1/00742

(57) ABSTRACT

A vehicle is provided that includes a passenger compartment, one or more movable body panels to expose the passenger compartment to an outside environment, and a motion sensor located in the passenger compartment. The vehicle also includes a temperature sensor located in the passenger compartment, and a controller operable to open the one or more movable body panels when the vehicle is turned off, movement is detected within the passenger compartment prior to opening any door of the vehicle, and temperature in the passenger compartment exceeds a temperature threshold.

### FIELD OF THE INVENTION

The present invention generally relates to vehicle temperature monitoring and control, and more particularly relates to reducing excessive temperature in a vehicle when the vehicle is keyed off and not operating.

### BACKGROUND OF THE INVENTION

Automotive vehicles are often prone to overheating due to the intense sunlight during hot summer days when the vehicle is not operating and hence, the heating, ventilation and cooling (HVAC) system is not operating. Excessive temperature within the closed vehicle passenger compartment of the vehicle can be detrimental to passengers and pets that may be left in the keyed off vehicle. In addition, excessive heat may cause deterioration of vehicle interior components, such as those made of plastic. For example, distortion and dimensional change, cracking and crazing, surface deposits that are often sticky, less flexibility, odor and a change in texture or color may occur due to excessive temperature. Accordingly, it is therefore desirable to provide for temperature reduction in a vehicle that is keyed off, particularly when one or more passengers or pets may be located in an enclosed passenger compartment of the vehicle on a hot sunny day.

### SUMMARY OF THE INVENTION

According to a one aspect of the present invention, a vehicle is provided that includes a passenger compartment, a movable body panel, and a motion sensor located in the passenger compartment. The vehicle also includes a temperature sensor located in the passenger compartment and a controller operable to open the movable body panel to expose the passenger compartment to an outside environment when the vehicle is turned off, movement is detected within the passenger compartment, and temperature in the passenger compartment exceeds a temperature threshold.

According to another aspect of the present invention a method of controlling temperature in a passenger compartment of a vehicle is provided. The method includes the steps of detecting a turned off state of the vehicle, detecting movement within the passenger compartment, and sensing temperature within the passenger compartment. The method also includes the step of controlling a movable panel to open the panel to reduce temperature within the passenger compartment when the vehicle is turned off, motion is detected within the passenger compartment, and the temperature exceeds a temperature threshold.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a rear perspective view of the passenger compartment of an automotive vehicle equipped with an over temperature control system, according to one embodiment;

FIG. 2 is a top view of the vehicle further illustrating components of the over temperature control system of FIG. 1 and the movable body panels in an open position;

FIG. 3 is a top view of the vehicle further illustrating the components of the control system and showing the movable body panels in the closed position;

FIG. 4 is a block diagram further illustrating the vehicle over temperature control system; and

FIG. 5 is a flow diagram illustrating a routine for reducing temperature in a vehicle, according to one embodiment.

### DETAILED DESCRIPTION OF THE PREFERRED EMBODIMENTS

As required, detailed embodiments of the present invention are disclosed herein;

however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

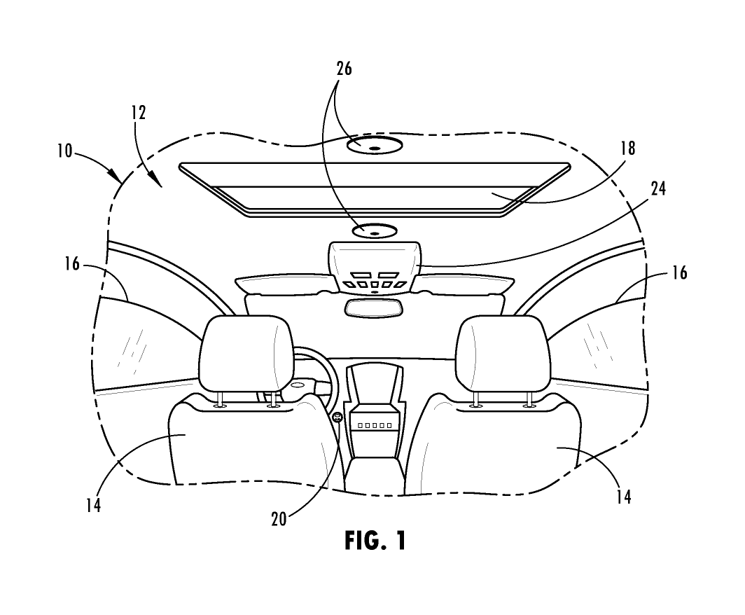

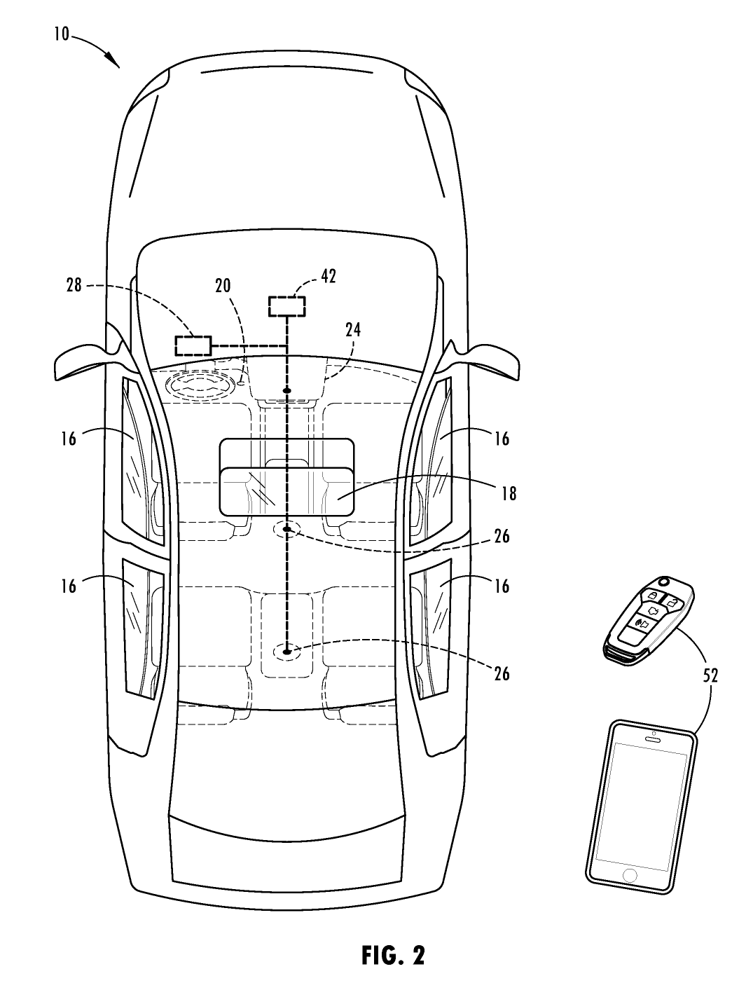

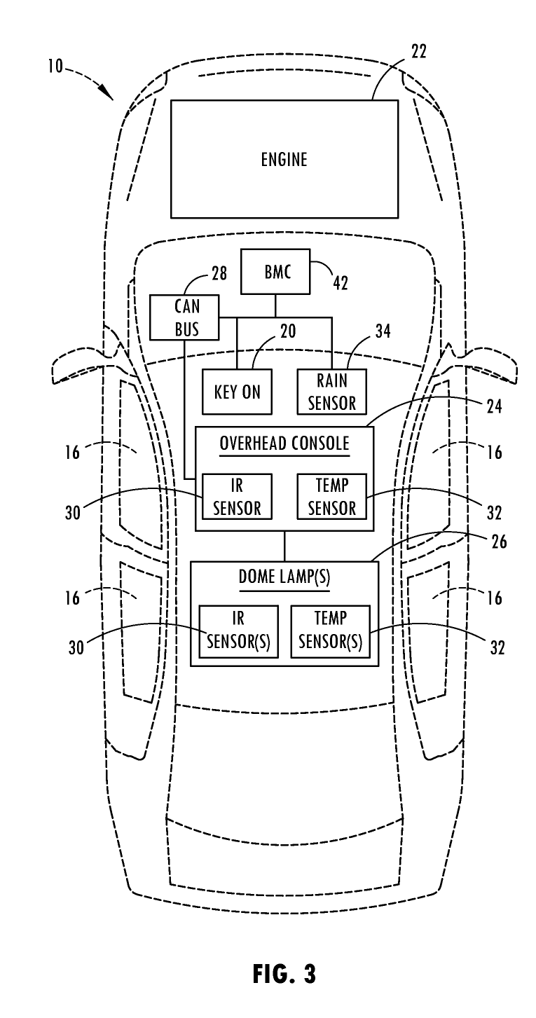

Referring to FIGS. 1-3, an automotive vehicle 10 is generally shown configured with an enclosed passenger compartment 12, also referred to as a cabin that has cabin over temperature control for reducing cabin temperature when the vehicle is turned off or keyed off and thus the engine is not operating. The automotive vehicle 10 may include any vehicle that has body panels defining an enclosure which contains a passenger compartment and generally isolates the passenger compartment 12 from the outside environment. The passenger compartment 12 may be equipped with passenger seats 14 for allowing one or more passengers to be seated within the passenger compartment 12. The vehicle 10 is further shown equipped with a plurality of movable body panels including door mounted movable windows 16 and a roof mounted movable sunroof panel 18. The windows 16 may each be actuated by an actuator, such as an electric powered motor, to move between a downward open position and an upward closed position. Similarly, the sunroof panel 18 may be driven by an electric powered motor or other actuator to move between a closed position and an open position. In the open position, the windows 16 and sunroof 18 expose the passenger compartment 12 to the outside ambient environment which allows air and thermal energy transfer to occur between the interior of the passenger compartment 12 and the outside environment. When the temperature inside the passenger compartment 12 exceeds the outside ambient temperature, cooling of the passenger compartment 12 can be realized when the movable body panels are in the open position. In the closed position of the movable body panels, air and temperature exchange between the passenger compartment 12 and the outside environment is more limited.

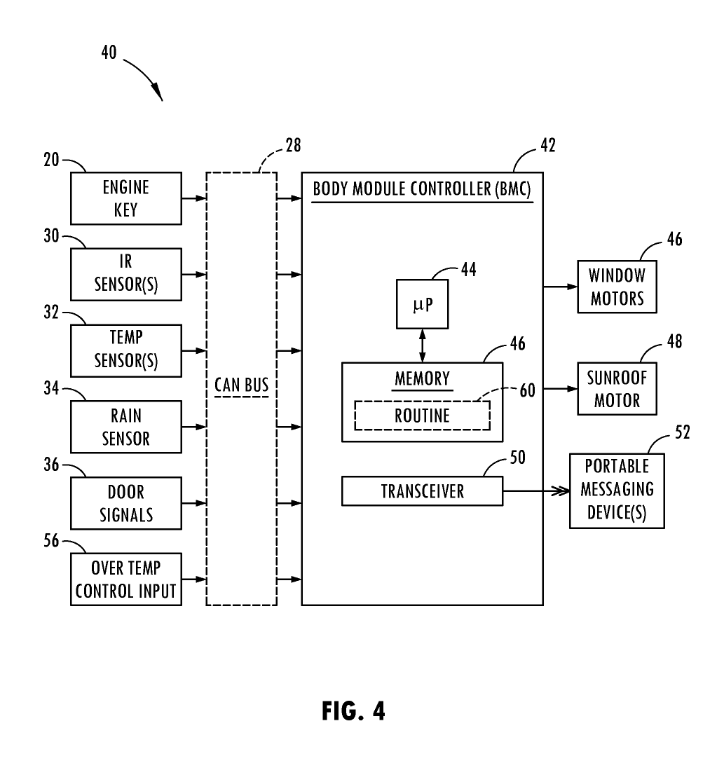

When the vehicle 10 is turned on or keyed on, i.e., the ignition key 20 is in the “on” position which occurs when the engine 22 is operating, the temperature within the passenger compartment 12 of the vehicle 10 may be controlled by way of the heating, ventilation and air conditioning (HVAC) system typically found on an automotive vehicle 10. However, when the vehicle 10 is turned off or keyed off i.e., the ignition key 20 is in the “off” position and the engine is therefore not operating, the vehicle passenger compartment 12 may become heated to an elevated temperature on a hot sunny day which may be detrimental to the vehicle 10 and to passengers and/or pets that may be located within the vehicle 10. In order to minimize the detrimental effects to objects including passengers and pets located within the passenger compartment 12, the vehicle 10 is equipped with an over temperature control system 40 shown in FIG. 4 that detects motion and temperature within the passenger compartment 12 and actuates one or more movable body panels such as windows 16 and sunroof 18 to an open position in an attempt to reduce the temperature as described herein.

As shown in FIGS. 1-4, the over temperature control system 40 includes a motion detector which may include one or more motion sensors 30 located in the passenger compartment 12 for detecting motion within the passenger compartment 12. The one or more motion sensors 30 may include infrared (IR) sensors, according to one embodiment. According to one specific embodiment, a first IR sensor 30 is located in the overhead console 24 and second and third IR sensors 30 are located in the respective first middle row and second rear row dome lamps 26. As such, the motion sensors 30 sense motion throughout a substantial volume of the vehicle passenger compartment 12 extending from the front seating area to the rear trunk area of the vehicle 10. The one or more motion sensors 30 may include active sensors that require electrical power to operate. The over temperature control system 40 may selectively activate the one or more motion sensors immediately following turning off the vehicle and the sensors may be activated for a predetermined time period and then deactivated after the predetermined time period expires. Thus, the sensor(s) may only be powered during the predetermined time period which may be thirty (30) seconds, according to one embodiment, and thereby may conserve power. The system may operate under the presumption that any object detected moving in the vehicle is presumed to remain in the vehicle up until one or more of the vehicle doors are opened. If one or more of the vehicle doors are opened, sensing of the passenger compartment for motion will then be reactivated. While a plurality of IR sensors are shown and described herein, it should be appreciated that other motion sensors such as ultrasonic sensors may be employed according to other embodiments.

In addition, the over temperature control system 40 includes one or more temperature sensors located in the passenger compartment 12. In one embodiment, a first temperature sensor 32 is located in the overhead console 24 and second and third temperature sensors are located in the respective middle row and rear row dome lamps 26. The temperature sensors 32 senses temperature within the interior of the passenger compartment 12 proximate to the overhead ceiling and are therefore able to detect overheating of the passenger compartment 12. Excessive temperatures within the vehicle passenger compartment may cause hyperthermia to any passengers or pets that may be exposed to the excessive temperature conditions. The temperature sensors 32 may be compensated for localized heating effects, such as temperature effects caused by the dome lamp and light source.

It should be appreciated that IR sensors 30 and temperature sensors 32 may be pre-existing sensors that are commonly found on a vehicle and used for other shared applications on the vehicle. The output signals generated by the IR sensors 30 and temperature sensors 32 may be communicated to a communication bus 28 which, in turn, makes the signals available to a controller 42 such as the body module controller (BMC) for use with the over temperature control system.

The over temperature control system 40 includes the controller 42 which is operable to cause one or more of the movable body panels 16 and 18 to open to an open position based on the sensed temperature, the sensed motion and other sensed parameters. The controller 42 receives and processes outputs of the IR sensors 30 and temperature sensors 32. In addition, the controller 42 may receive and process an engine key on signal from the engine key 20 indicative that the vehicle power is turned on and the vehicle is turned on or may receive an engine key off signal indicative that vehicle power is off and the vehicle is turned off. Further, the controller 42 may receive an output signal from a rain sensor 34 to indicate whether rain is detected on the outside of the vehicle 10. Door open and closed signals may further be made available to the controller 42 indicative of one or more vehicle doors being in the respective open or closed door positions. It should be appreciated that the various signals may be transmitted to the controller 42 via a communication bus 28, such as a CAN bus as is commonly employed on automotive vehicles.

The controller 42 is operable to open one or more of the movable body panels when the vehicle 10 is turned off or keyed off, movement is detected within the passenger compartment 12 prior to opening any door of the vehicle 10, and temperature in the passenger compartment exceeds a temperature threshold. When the vehicle 10 is keyed off, the windows 16 and sunroof 18 typically will be in a closed position. When the controller 42 senses the vehicle 10 is turned off, movement is detected within the passenger compartment prior to opening any door of the vehicle 10 and the temperature of the passenger compartment exceeds a high temperature threshold T_{H}, such as 100° F., the controller 42 causes actuation of one or more of the windows 16 and sunroof 18 so as to open one or more of the movable panels by a predetermined distance, such as four inches, to expose the inside environment of the passenger compartment 12 to the outside environment and thereby allow for air exchange and thermal cooling of the passenger compartment 12. Opening the one or more body panels to an open position will attempt to reduce the temperature within the passenger compartment 12 to a level that is less detrimental to passengers, pets or other objects located within the passenger compartment 12. By moving the one or more body panels by a predetermined distance that is less than a full opening position, such as four inches according to one example, the one or more body panels are not excessively opened to allow pets to jump out of the vehicle 10 through the window opening, yet provides air exchange and thermal cooling to the passenger compartment 12 within the vehicle 10.

When the controller 42 actuates the one or more body panels to the open position, the controller 42 may also send a message or signal to one or more portable messaging devices 52 which may include the vehicle key fob, a telecommunications device such as a smartphone or a pager or other portable electronic messaging device that a user may carry with them. As such, the user may be informed via the message or signal that the vehicle windows 16 and/or sunroof 18 have been actuated to an open position. In the event that the rain sensor 34 detects sufficient rain on the exterior of the vehicle 10, the controller receives the rain signal indicative of the rain condition and is operable to actuate the one or more movable body panels to the closed position to prevent excessive rain from entering the interior of the passenger compartment 12. It should further be appreciated that if the temperature within the vehicle passenger compartment 12 drops below a lower set temperature T_{L}, such as 95° F., the controller 42 may close the one or more movable body panels to the fully closed position. The one or more movable body panels may further include pinch protection which prevents closure of a movable body panel in the event that an object is located in a path of the closing body panel.

Referring to FIG. 4, the over temperature control system 40 is shown employing the body module controller as the controller 42 for receiving the various signals, processing the various input signals, and controlling the one or more movable body panels as described herein. It should be appreciated that other shared or dedicated controllers may be used to control the over temperature control process. Controller 42 may include a microprocessor 42 or other electronic circuitry. In addition, memory 46 is included which may store a routine 60 for processing and executing the over temperature control process. The controller 42 is shown receiving various inputs including signals from the engine key 20, the IR motion sensors 30, the temperature sensors 32, the rain sensor 34, and door open/closed sensors 54 which may be received via a vehicle communication bus 28. The controller 42 receives and processes the various input signals, executes control routine 60 and provides output signals to control the window motors 46 and sunroof motor 48 to activate the one or more movable body panels between open and closed positions. In addition, a transceiver 50 is shown providing wireless communication to transmit signals to one or more portable messaging devices 52.

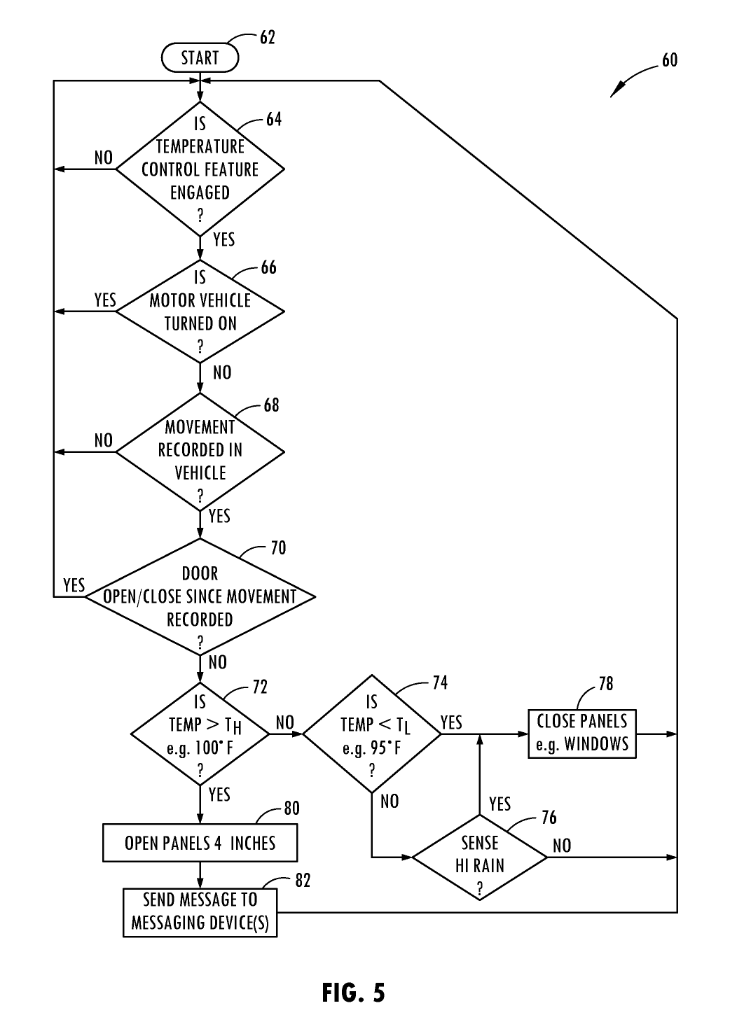

Referring to FIG. 5, the over temperature control routine 60 is illustrated according to one embodiment. Routine 60 begins at step 62 and proceeds to decision step 64 to determine if the temperature control feature is engaged and if not, waits for engagement of the feature. The temperature control feature may be engaged by a user input such as a touchscreen display or may otherwise be activated or deactivated. If the temperature control feature is engaged, routine 60 proceeds to decision step 66 to determine if the motor vehicle is turned on. This may include whether the vehicle is keyed on via the ignition key to operate the engine. If the motor vehicle is turned on and thus is turned off, routine 60 returns to step 64. If the vehicle is determined not to be turned on, routine 60 proceeds to decision step 68 to sense and record movement by an object within the vehicle. Movement of an object is sensed by using one or more motion sensors which are activated following detection that the vehicle has been turned off. The motion sensors may be activated for a predetermined time period, such as thirty (30) seconds. After the predetermined time period has expired, the motion sensors may be deactivated to conserve electrical power. The control routine 60 presumes that an object causing motion that is detected within the predetermined time period will remain within the vehicle until one or more of the vehicle doors are opened. If one or more of the vehicle doors are sensed to be open, routine 60 will reactivate the motion sensors. If no movement is recorded, method 60 returns to step 64. If movement is recorded within the vehicle, routine 60 proceeds to decision step 70 to determine if one or more vehicle access doors have been opened or closed since the last movement was recorded and, if so, returns to step 64. If one or more doors has not been opened or closed since the last movement was recorded, routine 60 proceeds to decision step 72 to determine if the passenger compartment temperature exceeds a predetermined high temperature limit T_{H}, such as 100° F., and, if so, proceeds to step 80 to open the panels (e.g., windows) by a predetermined distance, such as four inches, and then sends a message to one or more messaging devices to inform the driver or other user that the panels are open at step 82 before returning to step 64. If the passenger compartment temperature does not exceed the high temperature T_{H}, routine 60 proceeds to decision step 74 to determine if the sensed temperature is less than a low temperature T_{L,} such as 95° F. If the temperature has dropped below the low temperature T_{L}, routine 60 proceeds to step 78 to close or maintain closed the movable panels (e.g., window) before returning to step 64. If the temperature has not dropped below low temperature T_{L}, routine 60 proceeds to decision step 76 to sense rain on the outside body of the vehicle. If rain is sensed of a sufficient magnitude, routine 60 proceeds to step 78 to close the panels (e.g., windows) and then returns to step 64. If no rain is sensed, routine 60 proceeds to step 64.

Accordingly, the over temperature control system 40 advantageously opens one or more movable panels on a vehicle 10 in an attempt to efficiently reduce the temperature within the passenger compartment 12 of the vehicle 10 when the vehicle 10 is not operating. This may advantageously reduce the temperature within the passenger compartment 12 so as to minimize the detrimental effects to one or more passengers, pets or other objects located within the vehicle and thereby reduce the potential for hyperthermia. The over temperature control further keeps the vehicle interior at a cooler temperature which may advantageously reduce the air conditioner temperature pull-down time and prevent damage to interior components of the vehicle. The over temperature control system 40 advantageously employs sensors that are commonly employed on motor vehicles, and therefore requires minimal costs to effectuate.

It will be appreciated by those skilled in the art that although the invention has been described by way of example with reference to one or more embodiments it is not limited to the disclosed embodiments and that alternative embodiments could be constructed without departing from the scope of the invention as defined by the appended claims.

What is claimed is:

1. A vehicle comprising:
a passenger compartment;
a movable body panel;
a motion sensor located in the passenger compartment;
a temperature sensor located in the passenger compartment; and
a controller operable to open the movable body panel to expose the passenger compartment to an outside environment when the vehicle is turned off, movement is detected within the passenger compartment, and temperature in the passenger compartment exceeds a temperature threshold.

2. The vehicle of claim 1, wherein the controller opens the movable body panel after the vehicle is turned off and prior to opening any door of the vehicle.

3. The vehicle of claim 1, wherein the motion sensor is activated following turning off the vehicle for a predetermined time period, and is deactivated after the predetermined time period expires.

4. The vehicle of claim 1, wherein the movable body panel comprises one or more windows.

5. The vehicle of claim 1, wherein the movable body panel comprises a sunroof.

6. The vehicle of claim 1, wherein the controller controls the movable body panel to move the panel a distance less than a fully open position.

7. The vehicle of claim 1, wherein the controller closes the movable panel when the temperature returns below a set point temperature.

8. The vehicle of claim 1 further comprising a rain sensor, wherein the controller closes the movable panel when rain is detected by the rain sensor.

9. The vehicle of claim 1 further comprising a messaging device transportable by a driver of the vehicle, wherein the controller sends a message to the messaging device when the movable body panel is moved to an open position.

10. The vehicle of claim 9, wherein the messaging device comprises a vehicle key fob.

11. The vehicle of claim 9, wherein the messaging device comprises a telecommunications device.

12. A method of controlling temperature in a passenger compartment of a vehicle, comprising:
detecting a turned off state of the vehicle;
detecting movement within the passenger compartment;
sensing temperature within the passenger compartment; and
controlling a movable body panel to open the panel to reduce temperature within the passenger compartment when the vehicle is turned off, motion is detected within the passenger compartment, and the temperature exceeds a temperature threshold.

13. The method of claim 12, wherein the step of controlling the movable body panel to open the panel occurs after the vehicle is turned off and prior to opening any door of the vehicle.

14. The method of claim 12, wherein the step of detecting movement uses a motion sensor that is activated following turning off the vehicle for a predetermined time period, and is deactivated after the predetermined time period expires.

15. The method of claim 12, wherein the movable body panel comprises one or more windows.

16. The method of claim 12, wherein the movable body panel comprises a sunroof.

17. The method of claim 12, wherein the step of controlling the movable body panel causes the panel to move a distance less than a fully open position.

18. The method of claim 12 further comprising the step of closing the movable body panel when the temperature returns below a set point temperature.

19. The method of claim 12 further comprising the steps of sensing rain and closing the movable body panel when rain is sensed.

20. The method of claim 12 further comprising the step of sending a message to a messaging device when the movable body panel is moved to an open position.
